(19) United States
(12) Patent Application Publication
(10) Pub. No.: US 2025/0259036 A1
(43) Pub. Date: Aug. 14, 2025

(54) ARTIFICIAL INTELLIGENCE INTEGRATIONS WITH PERFORMANCE EVALUATION PLATFORM

(71) Applicant: BetterWorks Systems, Inc., Redwood City, CA (US)

(72) Inventor: Syam Sivadasan Pillai, Alappuzha (IN)

(21) Appl. No.: 18/441,818

(22) Filed: Feb. 14, 2024

(51) Int. Cl. G06N 3/0455

(52) U.S. Cl. CPC G06N 3/0455

(57) ABSTRACT

Techniques that enable users to generate an artificial intelligence (AI) integration configured to perform a task utilizing one or more machine learning models are described herein. An AI studio provides a user with options for creating a configuration object associated with an AI integration via a user interface. The AI studio may receive a request, from a user, to generate a prompt, the prompt defining an instruction to one or more machine learning model(s) (e.g., a large language model) to perform a task or generate an output based in part on input received from a user. A user may be presented with an option to select a type of transformer and deployment configuration to associate with the AI integration, the deployment configuration indicating an enterprise system and a deployment location within the enterprise system.

### BACKGROUND

Integrating artificial intelligence (AI) capability into a workflow has become increasing important as organizations seek to harness the power of AI to gain a competitive edge, streamline operations, and provide more personalized and efficient services to their clients or customers. However, developing custom AI solutions requires expertise in machine learning models and algorithms, and can be a complex task, involving data preparation, AI model training, integration with existing infrastructure, as well as ongoing maintenance and updates. As such, the benefits of AI are not accessible to non-engineers and employees at all levels of an organization.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to implement example techniques for generating an AI integration as described herein.

FIGS. 2A and 2B are pictorial flow diagrams outlining a first example method to generate an artificial intelligence (AI) integration using the techniques described herein.

FIG. 3 illustrates an example user interface displaying example AI integrations usable to perform tasks as described herein.

FIG. 4A-4C are pictorial flow diagrams outlining a second example method to generate an AI integration using the techniques described herein.

FIG. 5 illustrates an example user interface displaying an AI integration usable to perform a task as described herein.

FIG. 6 illustrates an example user interface displaying a second AI integration usable to perform a second task as described herein.

FIG. 7 illustrates an example user interface displaying multiple AI integrations usable to perform tasks as described herein.

FIG. 8 illustrates an example user interface that is usable to monitor the creation of transformer components using the techniques described herein.

FIG. 9 illustrates an example user interface that is usable to monitor AI integration data using the techniques described herein.

FIG. 10 is an example system and device that is usable to implement the techniques described herein.

### DETAILED DESCRIPTION

As discussed above, integrating AI features into existing systems, applications, platforms, etc. generally requires specialized knowledge. This application describes techniques for allowing users to quickly create, use, and monitor AI integrations using an AI studio platform or application based on limited inputs/experience by users. In some examples, the AI studio may be accessed from within an enterprise system. For instance, the AI studio may operate as a service that corresponds to a dedicated application installed on a user computing device. The AI studio may be accessed via an enterprise system associated with an organization (e.g., an employer) having one or more users (e.g., employees, independent contractors, volunteers, etc.). The enterprise system may enable users to share content via the application installed on the user device. In some cases, the shared content may be accessed (e.g., viewed) by devices associated with other users that also have the application installed on their respective devices. Alternatively or additionally, the enterprise system may enable users to share content, and/or access (e.g., view) content shared by other users accounts, via a web-based application accessed via web browser. The enterprise system may store account information associated with each user and the respective device on which the application is installed and/or via which the enterprise system is accessed.

The systems described herein describe an AI studio (or platform, service, etc.) that enables a user to create an AI integration that is configured to perform a task(s) automatically utilizing one or more machine learning models. The created AI integration may be integrated or incorporated an existing system, application, or process. The AI studio also enables a user to monitor and manage a performance of the AI integration(s), provided alerts, reports, analytics, recommendations, instructions, graphical user interfaces, etc. to a computer device associated with a user. The AI studio may provide tools to enable a user to specify what tasks one or more machine learning (ML) models can assist the user in performing. For example, a user that is not a software engineer and has no experience with creating or using machine learning models can quickly create and manage an AI integration that shortens the user's feedback to other users, rephrases a string of text to a different tone (e.g., comical tone, friendly tone, etc.), translates a string of text, provides suggested users that share similar goals, assists a user in initiating a conversation with another user, and the like. These and other techniques are described in further detail below.

### Example System Architecture

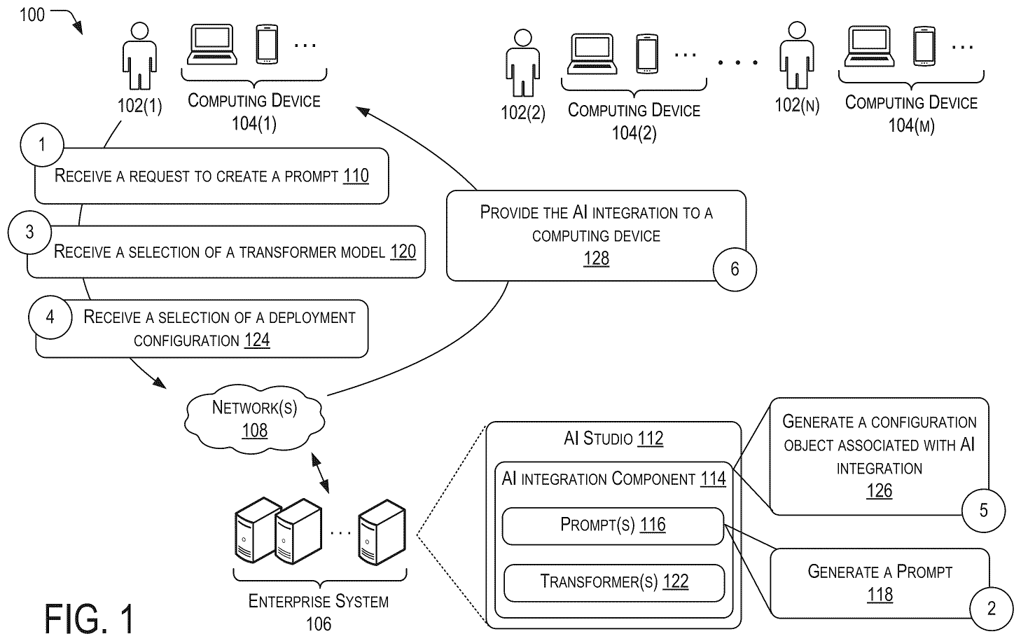

FIG. 1 is a schematic view of an example computing system 100 usable to implement example techniques described herein to facilitate generation of AI integration(s) on an application via system 100. In some examples, the system 100 may include users 102(1), 102(2), . . . 102(n) (collectively “users 102”) to interact using computing devices 104(1), 104(2), . . . 104(m) (collectively “computing devices 104”) with an enterprise system 106 via a network 108. In this example, n and m are non-zero integers greater than 1.

Each of the computing devices 104 includes one or more processors and memory storing computer executable instructions to implement the functionality discussed herein attributable to the various computing devices. In some examples, the computing devices 104 may include desktop computers, laptop computers, tablet computers, mobile devices (e.g., smart phones or other cellular or mobile phones, mobile gaming devices, portable media devices, etc.), or other suitable computing devices. The computing devices 104 may execute one or more client applications, such as a web browser (e.g., Microsoft Windows Internet Explorer®, Mozilla Firefox®, Apple Safari®, Google Chrome®, Opera®, etc.) and/or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 104 may access the enterprise system 106 and/or communicate with one another.

The enterprise system 106 may include one or more servers or other computing devices, any or all of which may include one or more processors and memory storing computer executable instructions to implement the functionality discussed herein attributable to the enterprise system or digital platform. The enterprise system 106 may enable its users 102 (such as persons or organizations) to interact with the enterprise system 106 and, in some cases, with each other via the computing devices 104.

The enterprise system 106 may include an artificial intelligence (AI) studio 112. In some examples, the AI studio 112 may be provided as a Software as a service (SAAS) that features software for building, executing, monitoring, and managing AI integrations. The AI integrations may be incorporated into an existing system (e.g., enterprise system 106) or application and assist users in automatically performing various tasks (e.g., generating a summary of a document, generating feedback for a user, identifying recommendations from a text, identifying users with similar goals, recommending goals, generating lists of competencies, and the like). The AI studio 112 may be in communication with one or more systems within an enterprise system, such as customer relationship management systems, financial systems, project management systems, issue tracking systems, and other systems that may be configured to measure, track, or store data regarding an organizations performance and goals. The AI studio 112 may operate in cooperation with the enterprise system 106. In some instances, the AI studio 112 may be accessed via a web browser, an application (e.g., desktop application, mobile application, etc.), and so on. In some examples, the AI studio 112 may, with input from a user, create and store in the AI studio 112 a user account associated with the user.

The AI studio 112 may be configured to facilitate the generation and management of AI integrations. The AI studio 112 may include various components, such as an AI integration component 114, a prompt(s) 116 component, a transformer(s) 122 component, and/or the like that facilitate the generation, performance, and monitoring of AI integrations. The AI studio 112 may be associated with one or more interfaces that are configured to receive input from a user and provide information. The AI studio 112 interface may present one or more tabs or sections including, for example, a User Interface (UI) components tab, a datasets tab, an API tabs, a prompt manager tabs, a transformers tab, a processing jobs tab, and the like that facilitate the creation and management of AI integrations. In some examples, the UI components tab may be configured to present data that enables a user (e.g., an admin user) to add, modify, delete, any UI components in the system. For example, an admin user may want to disable or enable an AI integration with a UI component. In some examples, the datasets tab may be configured to present data that enables a user to create a synthetic dataset. For example, the AI studio may be configured to receive an indication from a user to create a column(s) (or other individual data field within a dataset) and specify or define what the column is meant to be (e.g., a dataset definition, or specification of a dataset, representing a collection of data that is organized and stored in a manner that allows for easy access, management, and analyzation by the AI studio and/or enterprise system). That is, a predefined prompt may provide the column(s) a definition or an indication of a desired format of the dataset. In response to a request to generate data, API call(s) may be utilized to retrieve data, filter data, update data, etc. according to the specification of the dataset. In some examples, the an API tab(s) may be configured to present data related to API endpoints, functionalities, interaction data, or other data that assists a user (e.g., a developer) understand and use APIs effectively. In some examples, a prompt manager tab may be configured to enable a user to create, modify, and test prompts. In some examples, a transformers tab may be configured to present and facilitate the management (e.g., the creation, modification, deletion, testing, etc.) of transformers, such as those described herein. In some examples, a processing jobs tab may be configured to present data that enables a user to generate processing jobs. A processing job may be a task or operation that the AI studio is instructed to perform. For example, the AI studio may receive a request, from a user computing device, to generate a processing job configured to retrieve user feedback records from a database and tag each of the feedback as positive or negative. The processing jobs tab in the AI studio provides insight into the number of times the processing job was run, data on successful runs and/or unsuccessful runs, relevant logs, as well as presenting the results of the processing job run, and the like.

At operation 110 (indicated by “1”), a prompt(s) 116 component associated with the AI studio 112 may receive, from a user computing device, a request to generate a prompt. A prompt may be a specific input or instruction given to an AI model or ML model (e.g., a large language model (LLM)) to generate a desired response or output. That is, the prompt may be an instruction to an AI model in the form of a text string (e.g., a phrase or sentence) that defines a requested task or requested information. Various types of prompts may be generated based on a user's needs and preferences, including, for example, information prompts that request additional information, transformative writing prompts that transform a tone or language of a text (e.g., transform this feedback to be comical), content generation prompts (e.g., generate a list of competencies), personal assistance prompts (e.g., remind me to buy groceries at 6 PM, remind me to email a coworker, etc.), research assistance prompts (e.g., find information on recent advancements in transformer models), summarization prompts (e.g., summarize an email received from a coworker), an advice prompt (e.g., provide a goal suggestion based on other user's goals within the enterprise system), and the like.

A prompt may vary in complexity and format. For example, to generate a prompt that removes bias from feedback, a user may provide a string input that states “for the below given feedback, check to see if there are any indications of system bias, such as gender, color of skin, etc. If there are, please rephrase the feedback to convey the intent of the message in an objective and professional manner or to match a tone.” As an additional nonlimiting example, to generate a prompt that rephrases feedback or text to a different/particular tone, a user may provide “for the below given feedback, can you rephrase it to be causal and friendly?” As a further nonlimiting example, to generate a prompt that presents competencies, a user may provide “given a list of Lominger competencies, return a sentence that says something to the likes of “Core competencies identified include so and so.”

At operation 118 (indicated by “2”), the prompt(s) 116 component may generate a prompt in response to receiving the request to generate the prompt from a user computing device. In some examples, the prompt(s) 116 component may cause the prompt to be stored in a database. In some examples, in response to generating a prompt, the AI studio 112 may present, via a user interface, one or more transformers to associate with an AI integration.

At operation 120 (indicated by “3”), the AI studio 112 may receive, from a user 102(1) associated with a computing device 104(1), a selection of a type of transformer. In some examples, transformers may be managed by a transformer(s) 122 component associated with the AI studio 112. A transformer may be a type of machine learning model that can be used in natural language processing and other sequence-to-sequence tasks. A transformer may be configured to transform an input sequence of vectors into an output sequence by passing the input sequence of vectors through a series of encoder layers and decoder layers. Individual encoder layers may independently process the input sequence and capture important information using a self-attention mechanism. A self-attention mechanism allows a model to weigh the importance of different elements of input data when processing it. A transformer may be configured to process input data in parallel, handle sequences of different lengths, and capture dependencies in relationships within sequences of data (e.g., words in sentences or elements in a time series).

A transformer model may be pre-trained on large datasets and then fine-tuned for specific tasks. This reduces the need for massive amounts of task-specific training data. In some examples, a transformer may include a Bidirectional Encoder Representations from Transformers (BERT), Generative Pre-Trained Transformer (GPT), Text-to-text Transfer Transformer (T5), and the like.

In some instances, the AI studio 112 may receive from the user 102(1), a selection of one of an options transformer, a direct transformer, or a multi-step transformer. An options transform may be configured to accept more than one type of transformer at a following step. A direct transformer may be configured to provide a single type of value (e.g., a static value) as an output. In some examples, the AI studio may receive a selection of a different transformer, such as a Standard Temporal Fusion Transformer (TFT) (e.g., a model configured to combine the benefits of recurrent layers and attention mechanism to capture both local and global temporal dependencies effectively), a Localized Temporal Fusion Transformer (e.g., a variant of TFT that uses localized attention to focus on specific, more relevant time intervals, making it efficient for longer sequences), a Multi-Output Temporal Fusion Transformer (e.g. a model designed for multi-step forecasting and can predict multiple future time steps simultaneously while considering their interdependencies), a Hierarchical Temporal Fusion Transformer (e.g., a model that deals with hierarchical time series data, where observations can be grouped into various levels, such as daily and monthly sales data), and the like.

At operation 120 (indicated by “4”), the AI studio 112 associated with the enterprise system 106 may receive from the user 102(1) a selection of deployment configuration 124. A deployment configuration may be a set of parameters and/or settings that define how a software application (e.g., an AI integration) or system is deployed, run, and managed in a specific environment. A deployment configuration can vary depending on a type of system, a technology stack, and a deployment environment. In some examples, the user 102(1) may select a deployment configuration that defines the implementation location of the AI integration within the enterprise system 106, an application, or process in order to enhance the enterprise system's operations and capabilities. For example, the AI studio 112 may cause a user interface to be presented that enables the user to select a deployment system (e.g., enterprise system A, enterprise system B, etc.) and a location within the deployment system (e.g., a particular tab, section, application, etc.) to incorporate the AI integration. In some examples, integrating or incorporating the AI integration into an existing system (or a target system) may include requesting the user create an API. In some examples, the AI studio may send an authorization request or request permission from one or more enterprise system(s) before deploying the AI integration.

At operation 126 (indicated by “5”), an AI integration component 114 associated with the AI studio 112 may generate a configuration object based upon on AI integration settings a user selected thus far (e.g., the selected deployment configuration, the type of transformer, prompt, etc.). A configuration object may be used to encapsulate and organize various configuration settings or parameters for a particular component, module, or application (e.g., AI integration). For examples, the configuration settings may include API URLs, API keys, authentication tokens, and other relevant information that can be used by the AI studio, enterprise system etc. to make API calls or perform actions associated with a task. The configuration settings stored in association with the configuration object may be used to determine how and where to make API calls when an AI integration is initiated. The configuration object may serve to centralize and simplify the management of configuration options, making it easier to initialize and control behavior of a software. The configuration object may be used to store values that define how the AI integration behaves or interacts with external services, such as API endpoints (e.g., a particular URL or URI that is used as a point of entry for interacting with a web service or an application's API). An API endpoint may be associated with HTTP methods, such as GET, POST, PUT, PATCH, DELETE, and the like that indicate the type of operation that can be performed on the endpoint. In some examples, API endpoints may accept parameters that are used to specify additional details about the request and to customize the behavior of an API call. For example, parameters may be used to filter, sort, or manipulate the data being retrieved or modified (e.g., query parameters used for filtering, sorting, and/or paginating data, request headers to specify authentication tokens, language preferences, content type, and the like). The configuration object is then stored in a database and mapped to a target location. Any time a user reaches the target location, a GET call (or GET request) is made to an API endpoint to check if any AI integrations exist for the same. The configuration objects for AI integrations for that target location are returned to a front-end system that manages the user interface, network calls, etc. based off this configuration object.

The configuration object associated with the AI integration may be used to help perform the task. For example, when an AI integration is initiated (e.g., receiving user selection of an icon associated with the AI integration), the system may access the configuration object to retrieve values of specific configuration options (e.g., properties or fields within the configuration object set or modified as needed to customize behavior) which are used to guide the performance of the task. For example, if a task requires making an API call (e.g., to retrieve users with similar goals, retrieve competencies, etc.), the system may determine the API endpoint and/or API key from the configuration object.

Alternatively, or in addition to the operation 126, an AI integration component 114 associated with the AI studio 112 may generate an API associated with the AI integration. The API may be configured to access data stored in association with the enterprise system and assist the AI integration in performing the particular task. For example, a server associated with the enterprise system may send a request to an API associated with a large language model (LLM) that performs natural language processing (NLP), such as a Generative Pre-Trained Transformer 3 (GPT-3), Bidirectional Encoder Representations from Transformers (BERT), XLNet, Text-to-Text Transfer Transformer (T5), Conditional Transformer Language Model (CTRL), and the like.

At operation 128 (indicated by “6”), the AI studio 112 may provide the AI integration to a computing device 104(1). That is, the AI integration may be displayed in association with an icon, visual element, affordance etc. that, when selected or otherwise initiated by a user, can cause the AI integration to perform a task. Tasks may include, for example, identifying information (e.g., recommendations or action items from a conversation), recommending users (e.g., present users who have similar goals, present a user with whom to initiate a conversation based on prior conversations with the user), presenting action items, transforming a text string to have a different tone by applying linguistic and stylistic changes (e.g., calm tone, casual tone, kind tone, straight forward, formal tone, humorous, etc.), shorten a text string (e.g., shorten feedback to a user, summarize a text), generate a dataset (e.g., generate a sales report associated with a particular a period of time), present competencies for a user, identify key topics from a goal, translate a text string, and the like.

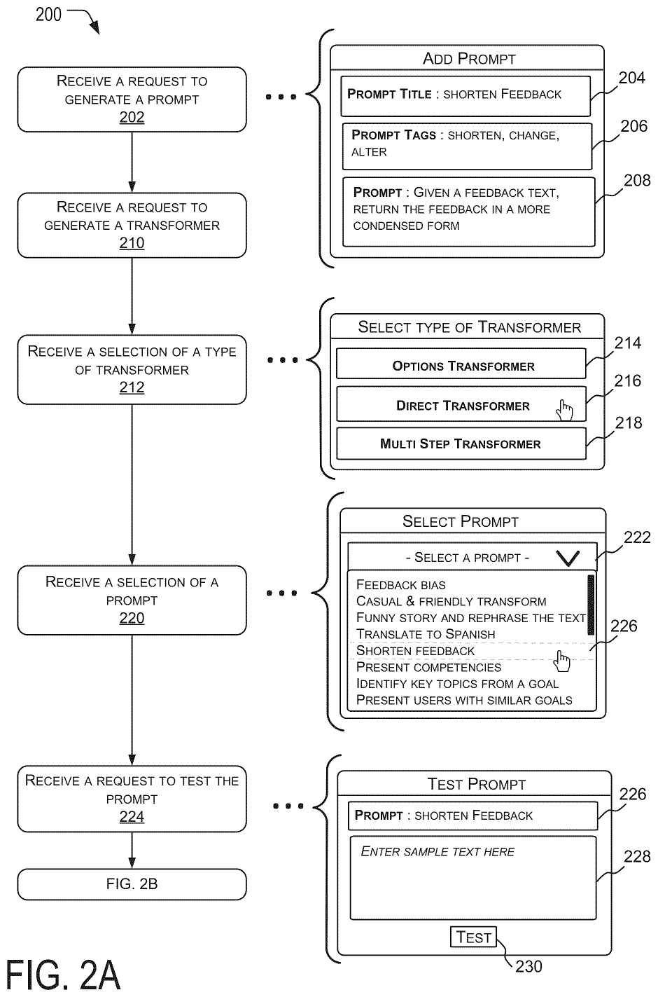

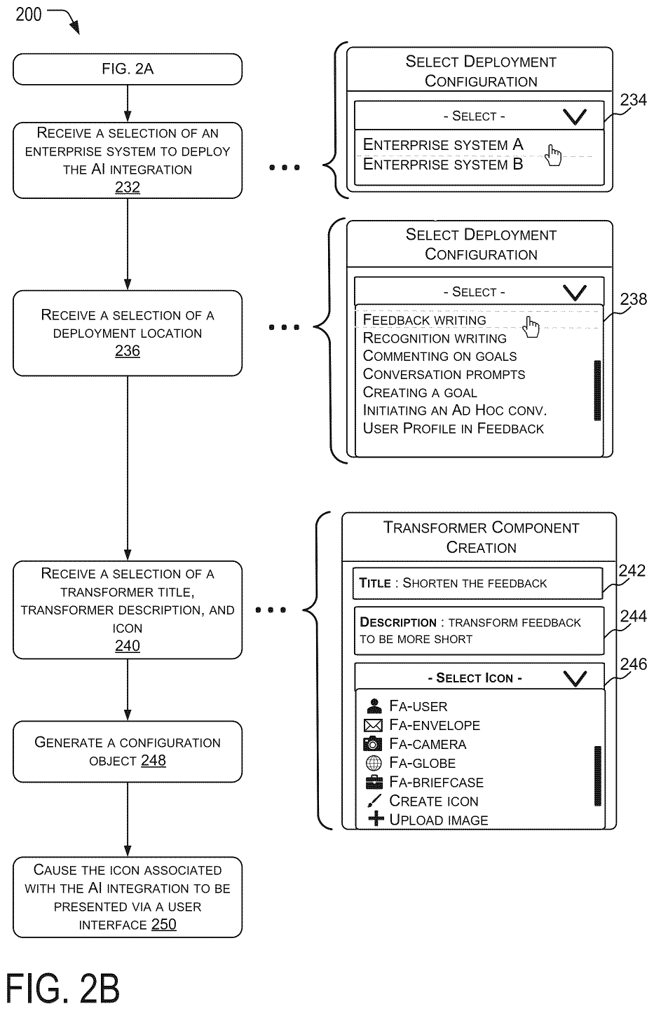

FIGS. 2A and 2B are pictorial flow diagrams outlining an example method 200 to generate an artificial intelligence (AI) integration using the techniques described herein. A user that may not have experience with machine learning models and/or does not have a software engineering degree may quickly and easily create, deploy, and manage an AI integration within an application using the AI studio. It should be appreciated that the logical operations described herein may be implemented (1) as a sequence of computer implemented acts or program modules running on a computing system and/or (2) as interconnected machine logic circuits or circuit modules with the computing system. The implementation is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital login, and any combination thereof. It should be appreciated that more or fewer operations may be performed than shown in the figures or described herein. These operations may also be performed in parallel, or in a different order than those described herein.

At operation 202, the AI studio receives a request, from a user computing device, to generate a prompt. In some examples, to initiate the generation of an AI integration, a user may select a “create AI integration” affordance associated with the AI studio. In response to selecting the “create AI integration” affordance, a user may be presented with an instruction to create or add a prompt. In some examples, a user may access a prompt tab (or prompt manager tab) associated with the AI studio and select an “add prompt” affordance or user interface element to initiate the creation of a prompt. As discussed above in relation to FIG. 1, a prompt may be an instruction to an AI model in the form of a text string (e.g., a phrase or sentence) that defines a requested task, requested information, or goal to be achieved. As illustrated in FIG. 2A, a prompt 208 may provide “given a feedback text, return the feedback text in a more condensed form.” However, this is merely an example and any text may be input to define a task.

In some examples, the request to generate a prompt may be associated with a user input indicating a prompt title 204 and one or more prompt tags 206 or labels. A prompt tag may be used to provide context, instructions, hints, or otherwise fine-tune the output response of an AI model like GPT-3 or other large language model. The prompt tag(s) may be used to guide the AI model's behavior and generate responses that align with the user's intentions or requirements. That is, a prompt tag may help set the context for the AI model by informing the AI model about the type of response or information the user is requesting and improving the accuracy of the output of the AI model associated with the AI integration. In some examples, a prompt tag(s) may serve as an explicit instruction to an AI model to summarize, translate, answer a question, write creatively, change a tone (i.e., friendly tone, formal tone, etc.), fetch particular data, and the like. These instructions may guide the AI model's behavior in generating responses. In multi-step tasks, a prompt tag(s) may be used to separate different parts of a task and instruct the model to respond to individual steps appropriately (e.g., first summarize, then generate an action item). In some examples, a prompt tag(s) may be used to specify a user role and/or system action. In some examples, a prompt tag(s) may direct the model to avoid particular content or responses (e.g., “avoid harmful or insensitive content” or “avoid including personally identifiable information”). In some examples, a prompt tag may indicate a level of detail or specificity to include in a response (or output) (e.g., “detailed” or “brief”). In some examples, a prompt tag may instruct an AI model to verify information that is output or presented to a user (e.g., verify information against a trusted source or trusted database). As illustrated in the particular example, a user may title a prompt that removes bias from feedback “Feedback Bias” and input prompt tags such as “shorten,” “change,” “alter,” to instruct the AI model.

In some examples, the AI studio may include a prompt component that generates, stores, and manages one or more prompts generated by a user(s) or an enterprise system. For instance, the prompt component may be configured to provide a list of prompts previously generated by a user, prompts generated by one or more users of the enterprise system, default prompts, and the like.

In some examples, the AI studio may generate and present a user with one or more default prompts (e.g., a template prompt) and/or suggested prompts that have previously been generated by one or more users and/or are recommended by the AI studio. For example, if a threshold number of users associated with the enterprise system generate a prompt directed to summarizing feedback, the AI studio may recommend the user create a prompt directed to summarizing feedback and/or recommend the AI integration that has already been generated. In some examples, the AI studio, based at least in part on usage data associated with a user (e.g., data relating to a user account information, messages, permissions, etc.), may recommend an AI integration to one or more users of the enterprise system. For instance, the AI studio may recommend a “feedback” AI integration for a user associated with a “manager” role within the enterprise system.

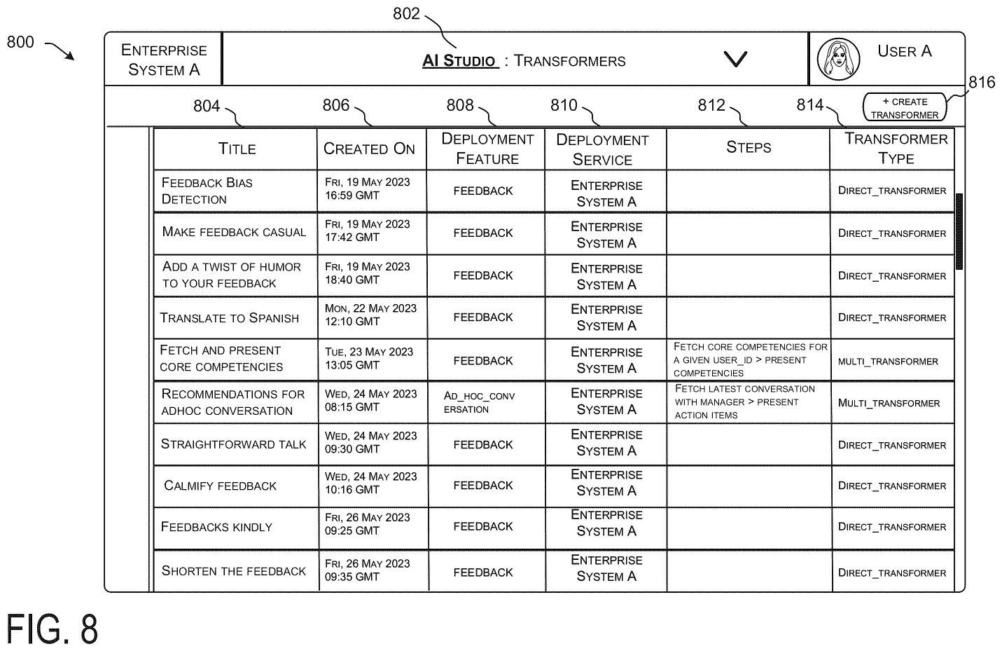

At operation 210, the AI studio may receive a request to generate a transformer. As discussed above in relation to FIG. 1, a transformer may be a type of machine learning model that can be used in natural language processing and other sequence-to-sequence tasks. The AI studio may provide an interface to enable a user to select a “create transformer” affordance (e.g., a “create transformer” affordance 816 depicted in FIG. 8). In some examples, in response to receiving a request to create a transformer, the AI studio may present the user with an option to select a type of transformer (e.g., via one or more affordances, text input, list, etc.). For instance, the AI studio may present a user with an options transformer 214 affordance, a direct transformer 216 affordance, and a multi-step transformer 218 affordance. In some examples, the AI studio may provide additional or other types of transformers, as described above with respect to operation 120.

At operation 212, the AI studio may receive a selection of a type of transformer. In some instances, the AI studio may receive, from the user, a selection of one of an options transformer 214, a direct transformer 216, or a multi-step transformer 218. In some examples, the AI studio may receive a selection of a different type of transformer, such as any of those discussed above in relation to FIG. 1. A user may select the type of transformer based on the task the transformer is to perform (e.g., language processing transformer, image generation, etc.). In some examples, individual transformers presented via a user interface may be associated with a description of the individual transformer's function. A description may be presented proximate each type of transformer and/or may be presented upon request (e.g., a user may select a “more information” affordance proximate a transformer type). A transformer description provides non software-engineers or users that are not experienced or well versed in machine learning techniques an understanding of what tasks the type of transformer model may be well suited for. In some examples, the AI studio may provide example outputs or tasks previously performed using individual transformer models. For example, to assist a user in selecting the appropriate type of transformer for a particular task, the user interface may provide AI integration examples, such as “feedback bias detection” and/or “make feedback casual,” and the like, proximate the “direct transformer” affordance. As another example, the user interface may provide “fetch and present core competencies for a given user” and/or “fetch latest conversation with manager>present action items,” proximate the “multi-step transformer” affordance as example AI integration(s) that use this type of transformer.

In some examples, in response to receiving a selection of a type of transformer, the AI studio may provide a user interface to enable a user to select a prompt 222 (e.g., via a list). That is, the AI studio may present the user with a list of prompt(s) the user has previously created, prompt(s) other users in the enterprise system have created, and the like. In some examples, the AI studio may provide a list of prompts organized based at least in part on date/time the prompts were created (e.g., most recently generated prompt may be presented at the top of the list), alphabetical order, popularity (e.g., present prompts or types of prompts that are most frequently used first or toward the top), type, etc.

At operation 220, the AI studio may receive a selection of a prompt. In the particular example, a user selects the shorten feedback prompt 226.

At operation 224, the AI studio may receive a request to test a performance of the prompt. Testing a performance of a prompt enables the user to determine whether to edit the prompt tags and/or prompt description before the AI integration is generated and integrated into the enterprise system. The AI studio may provide an interface to enable a user to enter (e.g., type) sample text 228 to test the performance of the prompt. In some examples, a user may copy text from a first location (e.g., a document, a message, an email, etc.) and paste the text into the sample text 228 box. A user may select test affordance 230 to initiate a test. In response to the request to test the performance and based at least in part on the type of transformer, the AI studio may cause a presentation of a result of the test. The user may test the performance of the prompt multiple times by entering new text into the sample text 228 box and selecting the test affordance 230.

At operation 232, the AI studio may receive a selection of an enterprise system to deploy the AI integration. That is, the AI studio software application may be deployed within multiple systems, platforms, applications, organizations. In some examples, AI studio may request permission to access a system, platform, application, etc. The AI studio may present (e.g., via a list) systems, platforms, applications, etc. that may be configured to incorporate AI integrations generated by the AI studio. In some examples, the AI studio may automatically present (or default to) the enterprise system that the user selected most recently. In the particular example, a user is presented with a system list 234 including Enterprise System A and Enterprise System B.

In response to receiving a selection of an enterprise system (e.g., Enterprise System A as shown in FIG. 2B), the AI studio may present a user with an option to select a deployment location. A deployment location allows a user to specify when and where the AI integration will be available for use within an enterprise system, platform, application, etc. In examples, a deployment location may represent a specific component, module, or feature of an enterprise system, platform, application etc. that is to execute or host the AI integration. In some examples, the presented deployment location(s) may depend on the selected enterprise system, platform, application, etc. For instance, a deployment location may be a “feedback writing” feature within the enterprise system, an objectives creation feature within the enterprise system, etc.

At operation 236, the AI studio may receive a selection of a deployment location. An AI integration may be integrated into a particular tab, section, application, feature etc. within an enterprise system. For example, an AI integration configured to modify feedback (e.g., shorten feedback, rephrase feedback, remove feedback bias, etc.) may be integrated into a “feedback writing” tab within Enterprise System A or anywhere within Enterprise System A that includes a feedback writing feature. In some examples, a user may specify multiple deployment locations within an enterprise system. For instance, a user may select a first deployment location (e.g., commenting on goals) and a second deployment location (e.g., creating a goal).

At operation 240, the AI studio may receive a selection of a transformer title 242, transformer description 244, and an icon to associate with the AI integration. The transformer title 242 may the same or different than the prompt title. The transformer description 244 may be a textual description of the transformer component's purpose and functionality (e.g., “transform feedback to be more short”). An AI studio interface may display to the user a list of icons 246, symbols, images, etc. to associate with the AI integration. In some examples, the icon may be a short animation (e.g., an active icon or image) or graphical element that is visually dynamic. The AI studio may provide an option to create an icon or upload an icon or image to associate with the AI integration. For instance, selecting a “create icon” affordance may cause the application to present data and tool(s) (e.g., a paint application in a separate window) that enable a user to create a custom icon to be presented in association with the AI integration. In some examples, the AI studio may present icons that have not previously been selected by the user to be associated with an AI integration, so as to prevent the use of the same icon with multiple, different AI integrations.

At operation 248, the AI studio may generate a configuration object based upon on settings a user selected thus far (e.g., the selected deployment configuration, the type of transformer, prompt, etc.). A configuration object may be used to encapsulate and organize various configuration settings or parameters for a particular component, module, library, or application. The configuration object may serve to centralize and simplify the management of configuration options, making it easier to initialize and control behavior of a software. The configuration object is then stored in a database and mapped to a target location. Any time a user reaches the target location, a GET call (or GET request) is made to an API endpoint to check if any AI integrations exist for the same. The configuration objects for AI integrations for that target location are returned to a front end that manages the user interface, network calls, etc. based off this configuration object.

Alternatively, or in addition to operation 248, based at least in part on the deployment configuration, the type of transformer, and the prompt, the AI studio may generate an API associated with an AI integration. The API associated with the AI integration may act as an agent or mechanism that allows applications or servers to interact and share data with each other. In other words, an API defines how software components may interact with each other and provides a way for a user to access the functionality of a particular application or service, without having to understand the underlying code. The generated API may assist the generated AI integration in performing requested tasks. The AI integration may be configured to perform a task utilizing one or more machine learning models (e.g., a large language model). For example, an AI integration configured to assist a user in writing feedback (i.e., a task) for another user may be generated based at least in part on the selected prompt, the selected type of transformer, and the selected deployment configuration (the deployment configuration indicating an enterprise system and a deployment location within the enterprise system).

At operation 250, in response to receiving a selection of a transformer title 242, transformer description 244, and/or icon, the AI studio may incorporate the AI integration into one or more features associated with the enterprise system. The AI studio may cause the icon associated with the AI integration to be presented via a user interface based at least in part on the deployment configuration. The AI studio may cause the icon to be presented within a particular user interface of an enterprise system, platform, application, etc. For instance, an AI integration usable to shorten feedback may be presented when a user provides feedback to another user (e.g., proximate a text field). In some examples, an AI integration may be presented based at least in part on the AI studio detecting a trigger event or determining the occurrence or non-occurrence of an event. A trigger event may be a user action or system event that automatically prompts the presentation of a particular AI integration. For example, a trigger event may be receiving login-in credentials (e.g., when a user logs into an enterprise system, an AI integration is presented to provide reminders and/or uncompleted action items from the prior workday), a time period (e.g., present an AI integration that recommends an action item based on a passage of time), a completion of a task (e.g., an AI integration may be triggered to present a new goal when a user achieves a milestone or accomplishes an objective), determining engagement metrics, and the like. In some examples, the non-occurrence of an event may trigger the presentation of a particular AI integration (e.g., not meeting the milestone of a goal in predetermined period of time may trigger an AI integration that assists a user in setting a new milestone, new goal, and/or to edit the current goal/milestone).

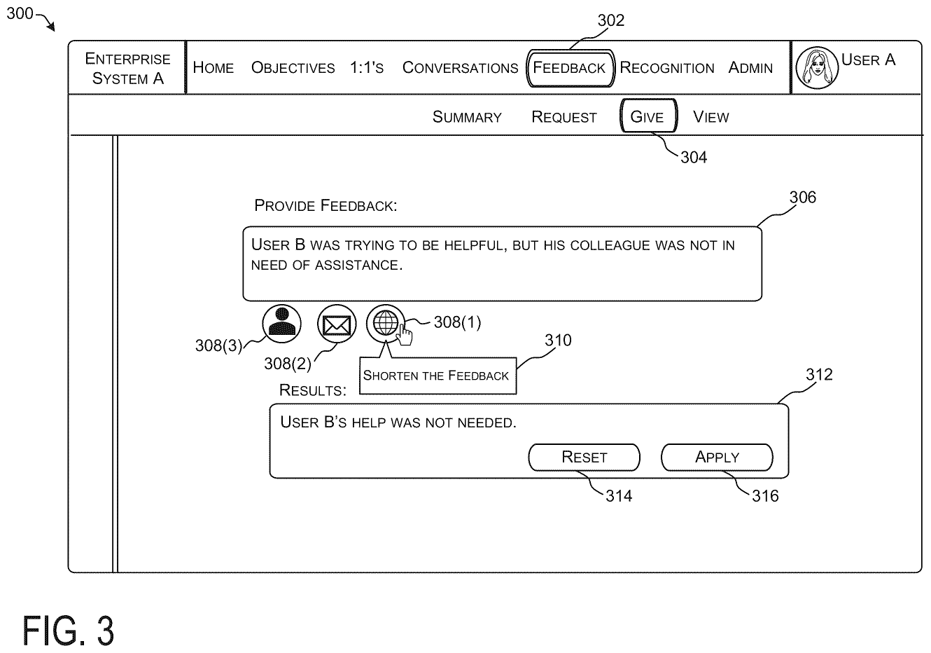

FIG. 3 depicts an example user interface 300 displaying an AI integration usable to perform a task. The user interface 300 includes information about an enterprise system (e.g., Enterprise System A), a user (e.g., User A), sections or tabs (e.g., home, objectives, 1:1's, conversations, feedback, recognition, admin, etc.), subsections or subtabs (e.g., summary, request, give, view, etc.). In the particular example, a user is viewing a “give” subtab 304 within the “feedback” tab 302. The user interface 300 is usable to provide feedback to another user (e.g., another employee). The user interface may include one or more AI integrations generated using the AI studio. For example, the user interface 300 presents a first AI integration 308(1) associated with a first icon, a second AI integration 308(2) associated with a second icon, and a third AI integration 308(3) associated with a third icon. In some examples, moving a cursor over an AI integration without selecting the AI integration causes the user interface 300 to present a title of the prompt associated with the AI integration (e.g., shorten the feedback), and/or a short description 310 of the AI integration. As an example, the first AI integration 308(1) may be an AI integration created to “shorten the feedback” for an employee or user, the second AI integration 308(2) may be an AI integration created to “present a most recent conversation” (e.g., an email, a message thread, etc.) with a particular user (e.g., User B to whom the feedback is directed to), the third AI integration may be an AI integration created to provide a recommended user or a list of recommended users to provide feedback to. These are merely examples and any type of AI integration or any number of AI integrations may be presented via a user interface.

In response to receiving an input indicative of selecting an AI integration, an AI model may generate an output based at least in part on the type of transformer associated with the AI integration. As discussed above, the AI model may be a large language model that performs natural language processing (NLP), such as a Generative Pre-Trained Transformer 3 (GPT-3), Bidirectional Encoder Representations from Transformers (BERT), XLNet, Text-to-Text Transfer Transformer (T5), Conditional Transformer Language Model (CTRL), and the like. For example, a user may input (e.g., touch input, keyboard input, spoken input, or any other type of input) feedback for another user or employee into text field 306 in the form of a text string.

Selecting the first AI integration 308(1) may cause an AI model (e.g., a large language model) to process the text string. For example, an AI model, may divide the input text string into tokens. In some examples, the tokens may be individual characters or whole words or sub-words. Individual tokens are converted into a numerical representation (e.g., word embeddings or token embeddings). Embeddings encode the meaning of the token into a continuous vector space, which enables the AI model to perform mathematical operations on the embeddings. Positional encoding may be added to the token embeddings. A self-attention mechanism may be used to weigh the importance of different tokens in relation to each other in order to capture context and dependencies between words in the input text string. In some examples, contextual data may be stored in a local storage/vector database with the embedding format. An AI model may include multiple layers of transformers or other neural network architectures and the input embeddings and positional encodings may pass through multiple layers to capture increasingly abstract features. The output of one layer may serve as the input to the next layer. The AI model may encode the tokens in a more contextualized manner at individual layers by considering the context of the entire input sequence. For a task involving text generation, an AI model may have a decoding mechanism that generates text based on the contextualized representations (e.g., beam search or sampling). The output of the AI model may be task-specific (e.g., the output may be a classification label, a sentiment score, a translation, a generated text sequence).

The output of the AI model associated with the AI integration may be presented via a user interface. For example, user interface 300 includes a results field 312. In some examples, the user may edit the results generated by the AI integration. In some examples, the output of the AI integration may be associated with one or more selectable controls. For example, a user may modify the text string input into text field 306 and select a reset 314 control to initiate generation of a second output (or updated output). In some examples, a user may select an apply 316 control to post the shortened feedback to a communication space, to send a notification to the user to whom the feedback was provided for, etc.

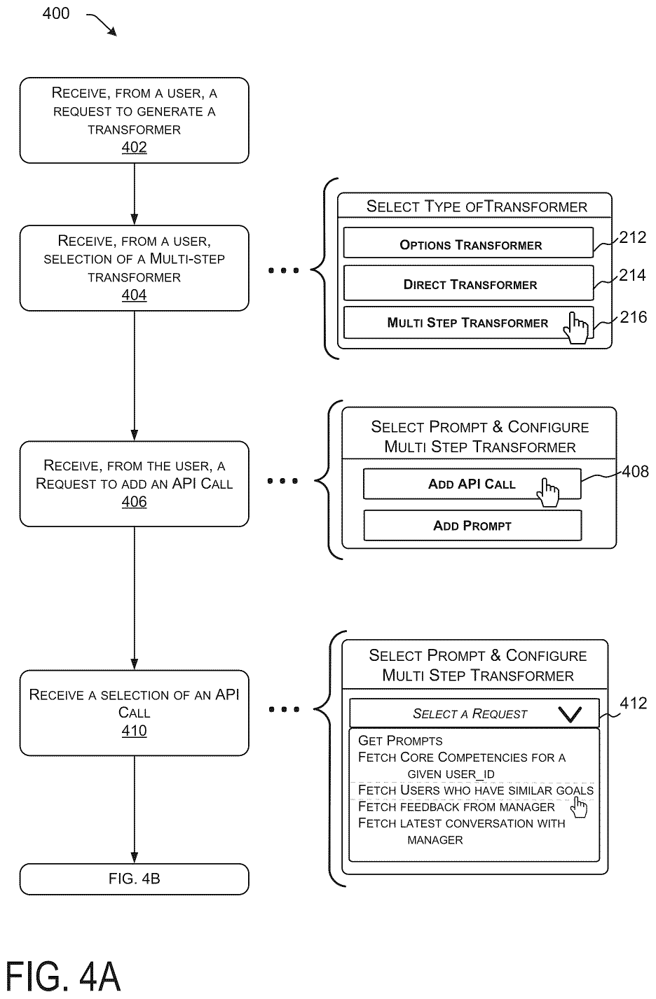

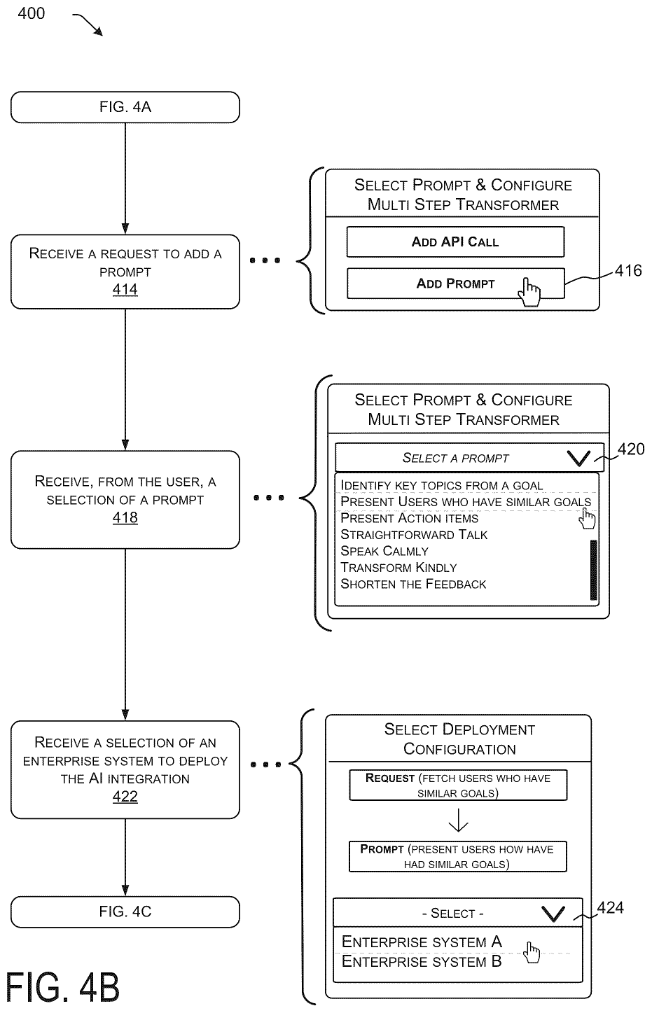

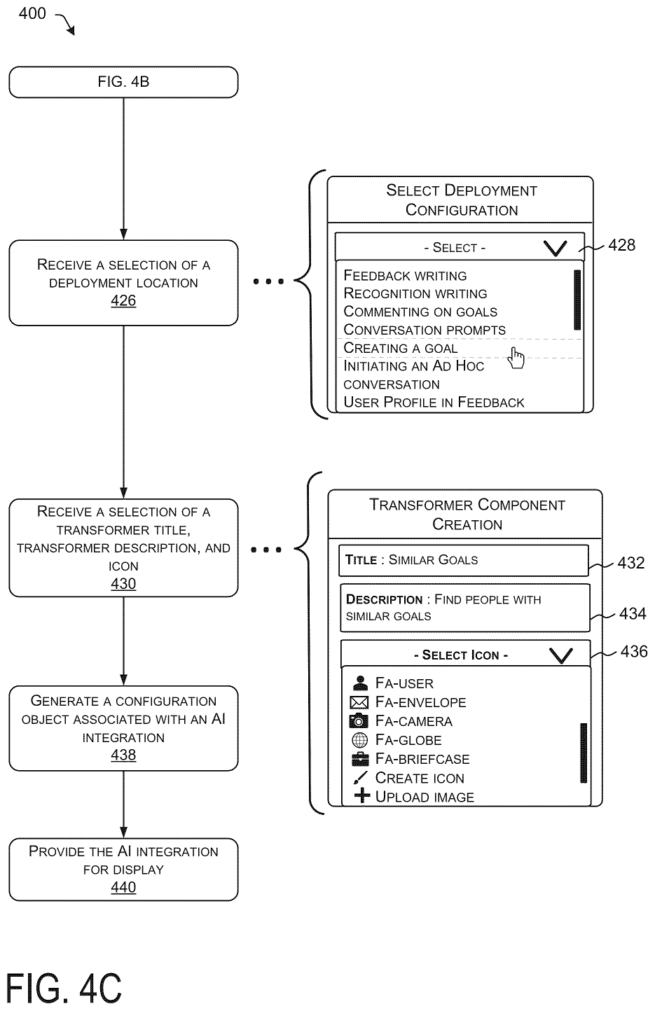

FIG. 4A-4C are pictorial flow diagrams outlining a second example method 400 to generate an AI integration. Various methods are described with reference to the example system of FIG. 1 and/or the example method of FIG. 2A and FIG. 2B for convenience and ease of understanding. However, the methods described are not limited to being performed using the systems of FIG. 1 or example method of FIGS. 2A and 2B, and may be implemented using systems and devices other than those described herein.

At operation 402, the AI studio may receive, from a user computing device, a request to generate a transformer or transformer component. For example, a user may select an affordance within a user interface associated with the AI studio to generate a transformer component. In response to receiving a request to generate a transformer component, the AI studio may present a list of two or more types of transformers (an options transformer 214, a direct transformer 216, or a multi-step transformer 218).

At operation 404, the AI studio may receive, from a user, a selection of a type of transformer (e.g., an options transformer 214, a direct transformer 216, or a multi-step transformer 218).

In some examples, in response to receiving a selection of the multi-step transformer 218, the AI studio may present a user with an affordance that enables a user to add an Application Programming Interface (API) call. An API call is a request made by one software application to another in order to access and use its functionality or data. An API may define a set of rules and protocols that allow software programs to communicate with each other and enable one program or application to retrieve data from another (e.g., a provider of data). An API may enable an AI model to access data and/or retrieve data from a database or other data source associated with one or more enterprise system(s), platform(s), application(s), etc.

At operation 406, the AI studio receives, from the user, a request to add an API call (e.g., a user may select an “add an API call” affordance 408). In response, the AI studio may present, via a user interface, an API call list 412 or drop-down menu including one or more existing API calls a user can select. In some examples, a user may be presented with an option to create an API call (not shown). Example API calls include getting a prompt, retrieving (or fetching) core competencies for a given user account, retrieving users who have similar goals, retrieving feedback from a manager, retrieving a most recent conversation with a manager, and the like.

At operation 410, the AI studio may receive a selection of an API call. In the particular example in FIG. 4A, a user selects the “fetch users who have similar goals” API call. That is, an API call may validate the user ID provided in the request to ensure the user ID is in a proper format and corresponds to a user ID found within enterprise system A. The API call may check whether the client or user making the request has the necessary permissions to access core competency information for the specified user. That is, an authentication can be performed to verify the requesting user's identity and authorization to confirm the client's access privileges or rights. For example, a new employee may not have access to core competencies of a manager, or access to communications between other employees, etc. Upon validating the user ID and verifying the requesting user is authenticated and/or authorized to access the data, the API may retrieve the core competency data associated with the user from a database or other data source. In some examples, the API may format, filter, and/or transform the data before presenting it to the user. In the event an error occurs (e.g., a requesting user is not authorized to access the requested information, a user ID is incorrect, the requested information is unavailable, etc.), the AI studio may cause an alert or error message to be presented to the user. In some examples, a cause of the error message (e.g., “no core competencies were found for User B”) may be presented in association with the alert or error message.

At operation 414, the AI studio may receive a request to add a prompt. For instance, a user may select an “add prompt” affordance 416. In response to receiving the request to add a prompt, the AI studio may present a user with a list 420 or drop-down menu of prompt(s) to associate with the AI integration. As a non-limiting example, prompts may include identifying key topics from a goal, present users who have similar goals, present action items, rephrase to speak calmly, transform text to speak kindly, shorten feedback, etc.

At operation 418, the AI studio receives, from the user, a selection of a prompt. For example, as shown in FIG. 4B, a user may select the “present users who have similar goals prompt.”

At operation 422, the AI studio may receive a selection of an enterprise system configured to deploy the AI integration. The AI studio may present (e.g., via a list) systems, platforms, applications, etc. that may be configured to incorporate AI integrations generated by the AI studio. In some examples, the AI studio may automatically present (or default to) the enterprise system that the user selected most recently. In the particular example, a user is presented with a system list 424 including Enterprise System A and Enterprise System B.

In response to receiving a selection of an enterprise system (e.g., Enterprise System A as shown in FIG. 4B), the AI studio may present a user with an option to select a deployment location. The deployment location may represent a specific component, module, or feature of an enterprise system, platform, application etc. that can execute or host the AI integration. In some examples, the presented deployment location(s) may depend on the selected enterprise system, platform, application, etc.

At operation 426, the AI studio may receive a selection of a deployment location. An AI integration may be integrated into a particular tab, section, application, feature etc. within an enterprise system. For example, an AI integration configured to identify and present users who have similar goals, recommend goals, set reminders for goals, etc. may be integrated into tabs, sub-tabs, and/or features within an enterprise system that relate to goal setting and/or monitoring. In some examples, the user may specify multiple deployment locations within an enterprise system. For instance, a user may select a first deployment location (e.g., commenting on goals) and a second deployment location (e.g., creating a goal).

At operation 430, the AI studio may receive a selection of a transformer title 432, transformer description 434, and an icon to associate with the AI integration. The transformer title 432 may the same or different than the prompt title. The transformer description 434 may be a textual description of the transformer component's purpose and functionality (e.g., “find people with similar goals”). An AI studio interface may display to the user a list of icons 436, symbols, images, etc. to associate with the AI integration.

At operation 438, based at least in part on receiving a selection of the deployment configuration, the type of transformer, and the prompt, the AI studio may generate a configuration object associated with an AI integration. The generated configuration object may assist the generated AI integration in performing requested tasks. The AI integration may be configured to perform a task utilizing one or more machine learning models (e.g., a large language model). For example, an AI integration configured to assist a user in writing feedback (i.e., a task) for another user may be generated based at least in part on the selected prompt, the selected type of transformer, and the selected deployment configuration (the deployment configuration indicating an enterprise system and a deployment location within the enterprise system).

At operation 440, based at least in part on the deployment configuration (e.g., the selected enterprise system and/or deployment location), the AI studio may incorporate the AI integration into one or more features associated with the enterprise system and present the AI integration for display via a user interface. That is, the AI studio may cause the icon associated with the AI integration to be presented via a user interface based at least in part on the deployment configuration. The AI studio may cause the icon to be presented within a particular user interface of an enterprise system, platform, application, etc. For example, as discussed in further detail below, an AI integration configured to assist a user in creating a goal may be presented in association with a goal setting user interface (e.g., a particular location) within a enterprise system.

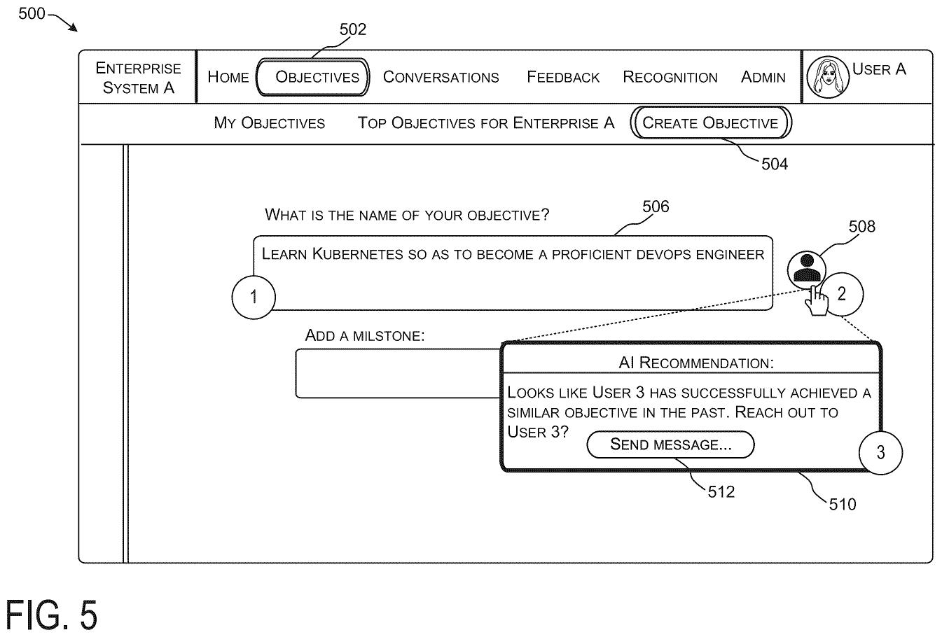

FIGS. 5-7 illustrate example user interfaces that include AI integrations usable to perform various tasks.

FIG. 5 illustrates an example user interface displaying an AI integration usable to perform a task. The user interface 500 may present a “create objective” 504 sub-tab within an objectives 502 tab and an objective box 506 that allows a user to create and define an objective. For example, as shown in FIG. 5, the objective or goal may be that a user would like to “learn Kubernetes so as to become a proficient DevOps engineer” (indicated by “1”). The user may also enter additional objective information including, for example, a milestone, a start and/or due date, an attribute of the objective (e.g., a category or type of objective, a scope of the objective, etc.) and the like. A user may select AI integration 508 (indicated by “2”) and cause the AI integration to perform a task (e.g., find and present users with similar objectives or goals). For instance, an API associated with the AI integration 508 may access objective or goal data stored in association with the enterprise system and present a recommendation to a user (indicated by “3”). Objective data may include information related to creation of goals or objectives, progress of objectives, types of objectives (e.g., personal development objectives, education objectives, project objectives, etc.), milestones, and the like. In some examples, the AI integration may be configured to access user data associated with the enterprise system, platform, or application. User data may include, for example, a user's role, position, hire date, messages sent between users via the enterprise system, user's goals, timeliness, performance evaluations permission data, search history, bookmarked data, engagement metrics, and other data that may be collected, stored, and/or accessible to the enterprise system.

In some examples, the AI recommendation 510 generated by the AI integration 508 may include a selectable control that provides additional functionality, such as a selectable control 512 usable to send a message to another user (e.g., a third user). In some examples, the AI recommendation 510 may include embedded links (not shown) that direct a user to another user's profile page, open a messaging window, cause a document to be downloaded, cause presentation of a webpage, etc.

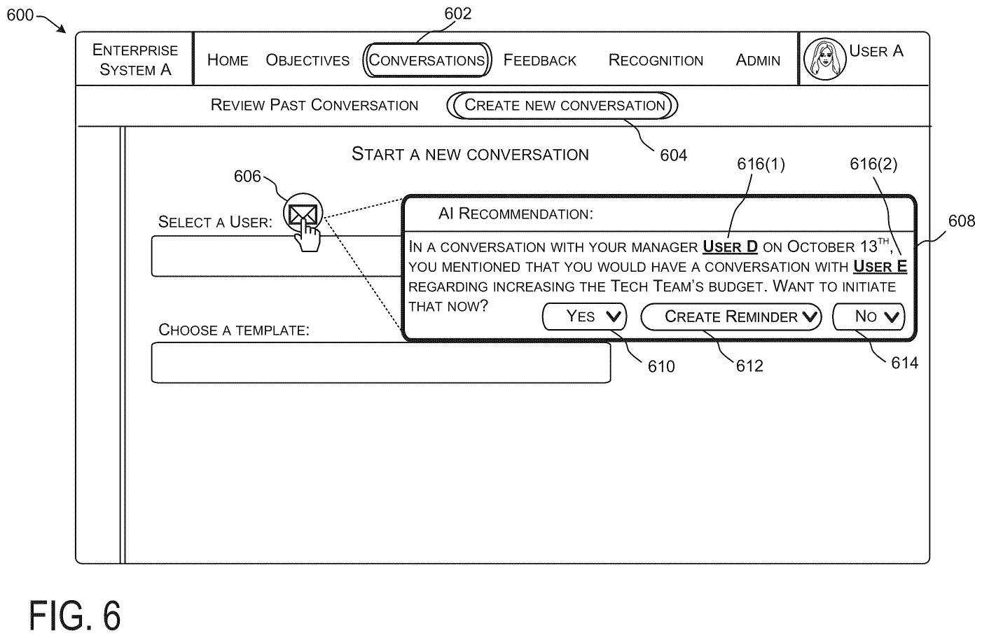

FIG. 6 illustrates an example user interface displaying an AI integration usable to perform a task as described herein. The user interface 600 may present a “create new conversation” 604 sub-tab within a conversations 602 tab within Enterprise System A. To assist a user in initiating a conversation with another user, a user may select AI integration 606 configured to provide a recommended user(s) with whom to initiate a conversation with. For instance, the AI integration may be associated with an API that retrieves conversation data associated with one or more users. Conversation data may include messages between users within a messaging application, direct messages, a business meeting (e.g., video conference meeting), voice assistance interactions, or any other type of accessible conversation data. In some examples, the AI integration may retrieve the most recent conversation data or retrieve conversation data that related to a particular topic (e.g., an important project, a client complaint, a budget increase etc.). In the particular example presented, the AI integration 606 presents a recommendation that states “in a conversation with your manager User D on October 13^{th}, you mentioned that you would have a conversation with User E regarding increasing the tech team's budget. Want to initiate that now?” The AI recommendation may be associated with one or more selectable controls that, when selected, initiate an action to be performed. For instance, a user may select a first control 610 (e.g., a “yes” selectable control) to initiate a conversation with the recommended user, User E. In some examples, selecting the first control 610 may cause a message template to be generated. For instance, a partially, prefilled email message may be generated and presented to the user (e.g., User E's contact information may be pre-filled in the email, and/or a message template). In some examples, a user may select a second control 612 (e.g., a “create reminder” selectable control) to initiate the creation of a reminder (e.g., a reminder task, add a reminder to a reminder list, create a calendar notification, etc.). In some examples, a user may select a third control 614 (e.g., a “no” selectable control) to cause the AI recommendation to close. In some examples, a user may additionally or alternatively provide feedback to the AI integration that the AI recommendation was not relevant, included incomplete or inaccurate information, etc.

In some examples, the AI recommendation 608 generated by the AI integration 606 may include embedded links. For instance, embedded link 616(1) may be associated with User D's user account and embedded link 616(2) may be associated with User E's user account. In some examples, selecting an embedded link may cause the user interface to present a new message composition window pre-populated with the recipient's email address. In some examples, an embedded link may cause the presentation of a document, a webpage, cause an application to launch, expand or reveal additional information, present a video or cause a video to be downloaded, and the link.

In some examples, if a user does not find a particular AI integration recommendation relevant, the user may re-select the AI integration 606 icon to initiate a generation of a second AI recommendation (not shown). In some examples, in the event an AI integration does not identify additional users with whom to initiate a conversation, the AI integration may cause a dialogue window to be presented that provides “no recent conversations were identified,” or the like.

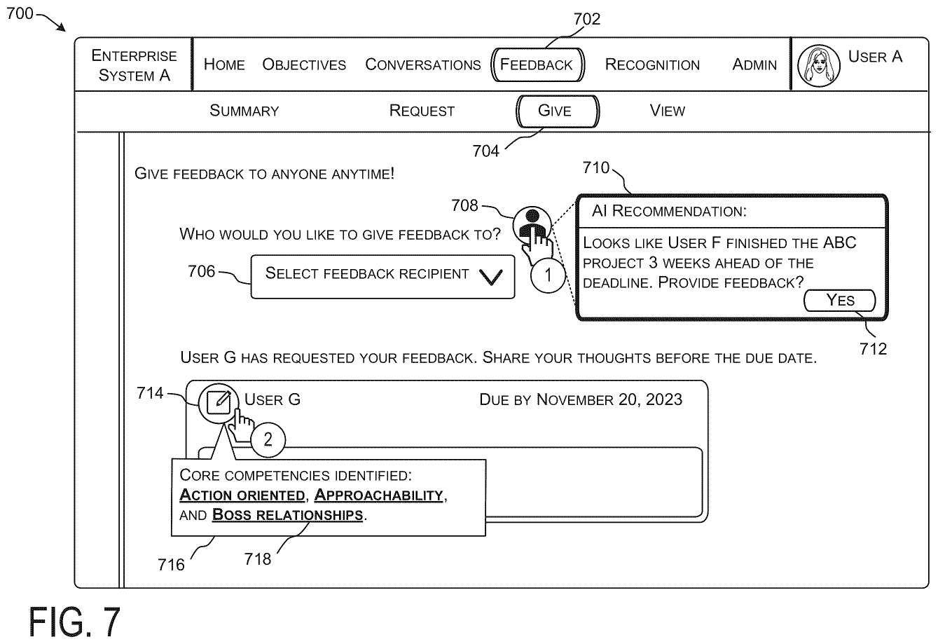

FIG. 7 illustrates an example user interface 700 displaying multiple AI integrations usable to perform tasks as described herein. User interface 700 presents a “give” 704 sub-tab within a feedback 702 tab within Enterprise System A. A user may select a feedback recipient via a pre-populated recipient list 706. To assist a user in identifying a feedback recipient (i.e., another user or user profile), the user may select a first icon associated with a first AI integration 708. The first AI integration 708 may be configured to retrieve user data and provide a recommended feedback recipient for whom to provide feedback to. For example, the AI integration 708 may retrieve one or more user's performance evaluations, docket or work schedule, client reviews, customer reviews, communications between users, and the like. Additional example user data is discussed above in relation to FIG. 5. For example, the AI integration may retrieve data related to a number of projects User F completed, timeliness on projects, efficiency on projects, sales revenue, number of sales completed, number of hours worked, and the like. In the particular example, the AI recommendation 710 provides a recommendation that states “looks like User F finished the ABC project 3 weeks ahead of the deadline. Provide feedback?” A user may select a “yes” control 712 to initiate a feedback or performance template. In some examples, the feedback template may be partially prefilled by the AI integration (e.g., a feedback recipient's contact information may be entered, etc.).

The user interface 700 may present one or more user's that request feedback and a due date associated with the requested feedback. For instance, User G has request feedback from User A and the feedback is due by Nov. 20, 2023. To assist User A in providing the requested feedback, User A may select (indicated by “2”) a second icon associated with a second AI integration 714. The second AI integration 714 may be configured to retrieve and/or identify one or more core competencies 716 associated with a user (e.g., User G that requested the feedback). Core competencies may represent an employee's skills, knowledge, and/or abilities. Core competencies may vary based on a job role, title, amount of time an employee has been employed at an organization, industry, etc. Core competencies may include a combination of technical, interpersonal, and behavioral skills such as communication skills, teamwork, problem-solving skills, adaptability, time management, technical skills, customer/client focus, leadership, attention to detail, self-motivation, project management, etc. In the particular example, the second AI integration 714 identified three core competencies (i.e., action oriented, approachability, and boss relationships) for User G. In some examples, one or more core competencies 716 may be associated with a link that, when selected, presents a source of the core competencies. For instance, selecting boss relationship 718 may cause a window to be presented of a recent message between User G and User G's boss that promotes a strong relationship, a completed task that contributed to the core competencies, etc.

FIG. 8 illustrates an example user interface 800 that is usable to monitor a list of created transformer components and accessed via the AI studio 802. The transformer component table may include multiple columns including title column 804, a date/time column 806, a deployment feature column 808, a deployment service column 810, a steps column 812, a transformer component type column 814. In some examples, the transformer table may include fewer or more columns providing additional and/or other information associated with generated transformer components. In some examples, a user may initiate the creation of a transformer component by selecting a “create transformer” affordance 816.

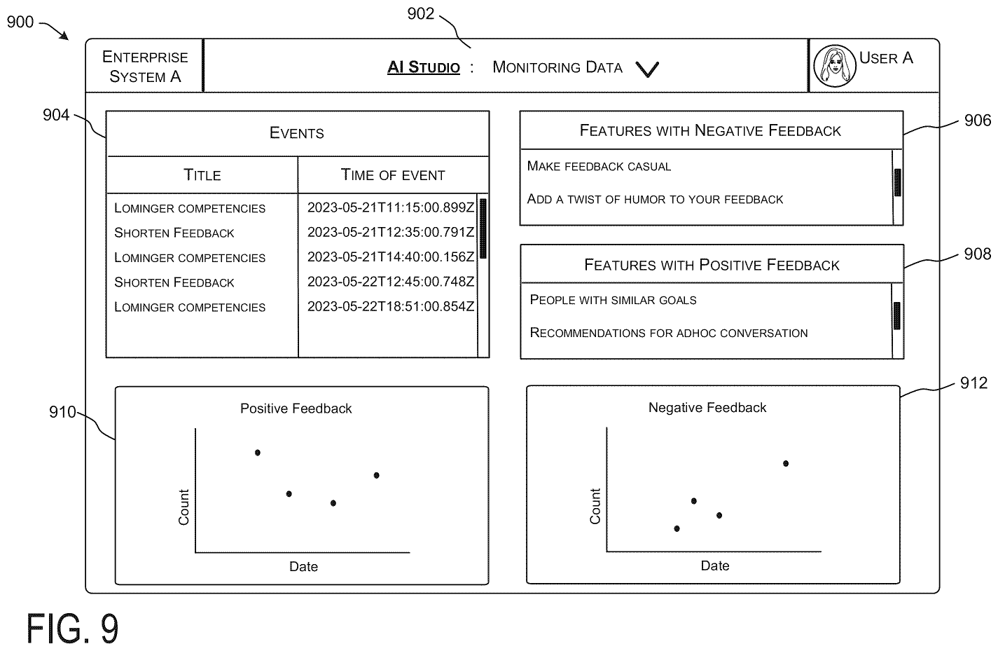

FIG. 9 illustrates an example user interface 900 that is usable to monitor and track AI integration data. The user interface 900 may include a feature flagging dashboard (or feature toggling dashboard) that provides visibility of AI integration features or functionality. Feature flagging enables users to control the behavior of created AI integrations in a flexible and fine-grained manner. For instance, a newly generated AI integration may be monitored for performance and feedback in order to determine which AI integrations provides the best user experience or utility. In the case of unforeseen errors or issues in the performance of an AI integration, a user may use the feature flagging dashboard to change (e.g., edit) settings associated with the input and/or output of an AI integration. A feature flagging dashboard provides users with the ability to test newly generated AI integrations on subsets of users within an enterprise system. That is, a user may compartmentalize an AI integration so that the user can easily turn the AI integration on or off without affecting the performance of other AI integrations.

In some examples, the AI studio may include a monitoring and maintenance component that monitors and reports on the AI integration's performance and user interactions. In some examples, the AI studio may provide a recommendation to update an AI integration as needed to adapt to changing conditions and data. The AI studio provides users the ability to monitor the performance of created AI integrations and review features that have received negative feedback 906 and/or features that have received positive feedback 908. In some examples, the AI studio may provide users with a positive feedback graph 910 and/or negative feedback graph 912 that presents a number of feedback (positive or negative) received through a day, week, (indicated by “date” on the x-axis). For example, individual AI integrations may be associated with an interactive feedback element that enables a user(s) to provide positive feedback indicating a response (or output) of the AI integration is accurate, helpful, or satisfactory. In some examples, the interactive feedback element may also enable a user to provide negative feedback indicating the response or output of the AI integration is inaccurate, unhelpful, or unsatisfactory. The AI studio may record the responses in a database and present them in may be recorded in a positive feedback graph 910 and/or negative feedback graph 912.

The AI studio may receive and monitor AI integration usage data associated with the use of AI integrations within the enterprise system. Usage data may include the input (e.g., a text string) and output (e.g., response or result of the request) processed by an AI integration. The AI studio may record events associated with the performance of an AI integration. Events may include errors that occurred due to a user's request (e.g., the user is not authorized to make this request or does not have permissions to access data associated with the request, the requested data does not exist, etc.). The AI studio may present events via an event table 904. The event table 904 may include a title of the AI integration (e.g., the prompt title) and a date/time the event occurred, and/or other information associated with a performance of the AI integrations. This provides visibility into the performance and functioning of AI integrations.

### Example System and Device

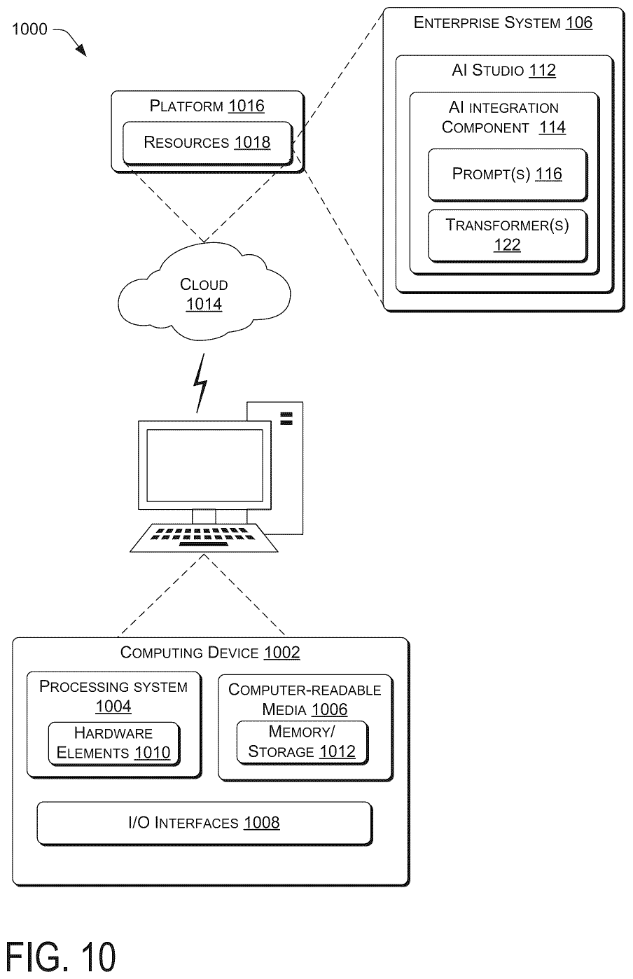

FIG. 10 illustrates an example system 1000 that includes an example computing device 1002 that is representative of one or more computing systems and/or devices that may implement the various techniques described herein. This is illustrated through inclusion of the enterprise system 106, the AI studio 112, the prompt(s) 116 component, and the transformer 122 component. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including a memory/storage component 1012. The memory/storage component 1012 represents memory/storage capacity associated with one or more computer-readable media. The memory/storage component 1012 may include volatile media (such as random access memory (RAM)) and/or nonvolatile media (such as read only memory (ROM), Flash memory, optical disks, magnetic disks, and so forth). The memory/storage component 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 1002. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 1002, such as via a network. Computer-readable transmission media typically may transmit computer-readable instructions, data structures, program modules, or other data in a modulated data signal, such as carrier waves, data signals, or other transport mechanism. Computer-readable transmission media also include any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 1010 and computer-readable media 1006 are representative of modules, programmable device logic and/or device logic implemented in a hardware form that may be employed in some examples to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

The techniques described herein may be supported by various configurations of the computing device 1002 and are not limited to the specific examples of the techniques described herein. This functionality may also be implemented all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 may include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 may abstract resources and functions to connect the computing device 1002 with other computing devices. The platform 1016 may also be scalable to provide a corresponding level of scale to encountered demand for the resources 1018 that are implemented via the platform 1016. Accordingly, in an interconnected device example, implementation of functionality described herein may be distributed throughout multiple devices of the system 1000. For example, the functionality may be implemented in part on the computing device 1002 as well as via the platform 1016 which may represent a cloud computing environment, such as the cloud 1014.

### CONCLUSION

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, from a user, a request to generate a prompt, the prompt defining an instruction to one or more machine learning models to perform a task or generate an output based at least in part on an input received from a user;
receiving, from the user, a selection of a type of transformer, the transformer configured to transform an input sequence of vectors into an output sequence by passing the input sequence of vectors through a series of encoder layers and decoder layers;
receiving, from the user, a selection of the prompt;
receiving, from the user, a deployment configuration, the deployment configuration indicating an enterprise system and a deployment location within the enterprise system;
receiving, from the user, a selection of an icon;
generating, based at least in part on the deployment configuration, the type of transformer, and the prompt, a configuration object associated with an artificial intelligence (AI) integration, the AI integration configured to perform the task utilizing the one or more machine learning models; and
presenting, via a user interface and based at least in part on the deployment configuration, the icon associated with the AI integration.

2. The method of claim 1, wherein the request to generate the prompt is associated with a user input indicating a prompt title and one or more tags.

3. The method of claim 1, wherein the task is associated with at least one of:
generating a summary of a document or message;
generating feedback for a user;
identifying recommendations from a text;
identifying a user with a similar goal;
generating a list of competencies;
identifying a topic from a goal;
rephrasing a text to remove bias; or
rephrasing a text to match a tone.

4. The method of claim 1, wherein the transformer comprises at least one of an options transformer, a direct transformer, or a multi-step transformer.

5. The method of claim 4, further comprising:
based at least in part on receiving a selection of the multi-step transformer to associate with the AI integration, causing presentation of a graphical element to enable selection of an API call; and
receiving, from the user, a selection of an API call to associate with the AI integration.

6. The method of claim 1, further comprising:
receiving a request to test a performance of the prompt, the request including sample text;
generating, based at least in part on the sample text and the type of transformer, a result of the test; and
presenting, via the user interface, the result of the test proximate the sample text.

7. The method of claim 1, further comprising:
receiving AI integration usage data;
determining an error occurred in association with the output of the AI integration; and
presenting an error message indicating a cause of the error.

8. The method of claim 1, further comprising:
receiving AI integration data associated with the generation of the AI integration; and
generating a transformer table to be displayed at a computing device, the transformer table comprising a title of the transformer, a date the transformer was generated, a deployment feature associated with the transformer, a deployment configuration associated with the transformer, and a transformer type.

9. The method of claim 1, further comprising:
receiving, from the user, a selection of the icon associated with the AI integration; and
generating, based at least in part on the selection of the icon and the prompt, the output of the AI integration, the output associated one or more selectable controls.

10. The method of claim 1, wherein the prompt is a first prompt, the instruction is a first instruction, and the task is a first task, the method further comprising:
receiving, in addition to the first prompt, a selection of a second prompt different than the first prompt, the second prompt defining a second instruction to the one or more machine learning models to perform a second task;
receiving, from the user, a selection of the icon associated with the AI integration; and
based at least in part on the selection of the icon, the first prompt, and the second prompt, generating the output of the AI integration.

11. One or more non-transitory computer-readable media storing instructions that, when executed by one or more processors, cause the one or more processors to perform operations comprising:
receiving, from a user computing device, a request to generate a transformer;
receiving, from the user computing device, a selection of a type of transformer;
receiving, from the user computing device, a selection of a prompt, the prompt defining an instruction to one or more machine learning models to perform a task or generate an output based at least in part on an input;
receiving, from the user computing device, selection of a deployment configuration, the deployment configuration indicating an enterprise system to deploy an artificial intelligence (AI) integration and a deployment location within the enterprise system;
receiving, from the user computing device, a selection of an icon to associate with the AI integration;
generating, based at least in part on the type of transformer, the prompt, and the deployment configuration, a configuration object associated with the AI integration; and
displaying, based at least in part on the deployment configuration, the icon associated with the AI integration in a user interface associated with the user computing device.

12. The one or more non-transitory computer-readable media of claim 11, wherein the transformer comprises at least one of an options transformer, a direct transformer, or a multi-step transformer.

13. The one or more non-transitory computer-readable media of claim 11, wherein an output of the transformer is associated with at least one of:
generating a summary of a document or message;
generating feedback for a user;
identifying recommendations from a text;
identifying a user with a similar goal;
generating a list of competencies;
identifying a topic from a goal;
rephrasing a text to remove bias; or
rephrasing a text to match a tone.

14. The one or more non-transitory computer-readable media of claim 11, the operations further comprising:
receiving a request to test a performance of the prompt, the request including sample text; and
causing, in response to the request and based at least in part on the type of transformer, presentation of a result of the test.

15. The one or more non-transitory computer-readable media of claim 11, the operations further comprising:
receiving a selection of a multi-step transformer to associate with the AI integration;
displaying, based at least in part on the selection of the multi-step transformer, a graphical element to enable selection of an Application Programming Interface (API) call; and
receiving, from the user computing device, a selection of an API call to associate with the AI integration.

16. A system comprising:
one or more processors; and
one or more non-transitory computer-readable media storing instructions that, when executed by the one or more processors, cause the one or more processors to perform operations comprising:
receiving, from a user computing device, a request to generate a transformer;
receiving, from the user computing device, a selection of a type of transformer;
receiving, from the user computing device, a selection of a prompt, the prompt defining an instruction to one or more machine learning models to perform a task or generate an output based at least in part on an input;
receiving, from the user computing device, selection of a deployment configuration, the deployment configuration indicating an enterprise system to deploy an artificial intelligence (AI) integration and a deployment location within the enterprise system;
receiving, from the user computing device, a selection of an icon to associate with the AI integration;
generating, based at least in part on the type of transformer, the prompt, and the deployment configuration, a configuration object associated with an AI integration; and
displaying, based at least in part on the deployment configuration, the icon associated with the AI integration in a user interface of the user computing device.

17. The system of claim 16, the operations further comprising:
receiving a selection of the icon associated with the AI integration; and
generating, based at least in part on the selection of the icon and the prompt, an output of the AI integration, the output associated one or more selectable controls.

18. The system of claim 16, the operations further comprising:
receiving AI integration data associated with the generation of the AI integration; and
generating a transformer table to be displayed at the user computing device, the transformer table comprising a title of the transformer, a date the transformer was generated, a deployment feature associated with the transformer, a deployment configuration associated with the transformer, and a transformer type.

19. The system of claim 16, the operations further comprising:
receiving AI integration usage data;
determining an error occurred in association with an output of the AI integration; and
displaying an error message indicating a cause of the error.

20. The system of claim 16, wherein the prompt is a first prompt, the instruction is a first instruction, and the task is a first task, the operations further comprising:
receiving, in addition to the first prompt, a selection of a second prompt different than the first prompt, the second prompt defining a second instruction to the one or more machine learning models to perform a second task;
receiving, from the user, a selection of the icon associated with the AI integration; and
based at least in part on the selection of the icon, the first prompt, and the second prompt, generating the output of the AI integration.
